(19) United States
(12) Patent Application Publication
(10) Pub. No.: US 2021/0370738 A1
(43) Pub. Date: Dec. 2, 2021

(54) DAMPING CONTROL DEVICE AND DAMPING CONTROL METHOD

(71) Applicant: Toyota Jidosha Kabushiki Kaisha, Toyota-shi Aichi-ken (JP)

(72) Inventor: Hiroki Furuta, Numazu-shi (JP)

(73) Assignee: Toyota Jidosha Kabushiki Kaisha, Toyota-shi Aichi-ken (JP)

(21) Appl. No.: 17/307,303

(22) Filed: May 4, 2021

(30) Foreign Application Priority Data
Jun. 2, 2020 (JP) 2020-096043

(51) Int. Cl. B60G 17/0165; B60G 17/018

(52) U.S. Cl. CPC B60G 17/0165; B60G 17/018; B60G 2800/162; B60G 2500/00; B60G 2600/182; B60G 2204/62

(57) ABSTRACT

A damping control device for a vehicle calculates a weighted sum of a first control force of feedforward control and a second control force of feedback control as a target value of a damping control force. When a degree of a deviation of a path of a rear wheel from a path of a front wheel is larger than a predetermined first degree, the damping control device sets a weight for the second control force to be larger than a weight for the first control force in the weighted sum.

### CROSS-REFERENCE TO RELATED APPLICATION

This application claims priority to Japanese Patent Application No. 2020-096043 filed on Jun. 2, 2020, incorporated herein by reference in its entirety.

### BACKGROUND

### 1. Technical Field

The present disclosure relates to a damping control device and a damping control method for a vehicle.

### 2. Description of Related Art

Hitherto, there is a proposal for a device (hereinafter referred to as “related-art device”) configured to perform damping control for a sprung portion of a vehicle by using information related to a vertical displacement of a road surface where a wheel of the vehicle is predicted to pass (for example, Japanese Unexamined Patent Application Publication No. 2009-119948 (JP 2009-119948 A)). Such control is referred to also as “preview damping control”.

When the vehicle makes a turn, a rear wheel may pass along a road surface different from a road surface where a front wheel has passed. In this case, a displacement (vertical displacement) of the road surface where the rear wheel passes may differ from a displacement of the road surface where the front wheel passes. When the preview damping control is executed for the rear wheel in this situation based on information related to the displacement of the road surface that is used for the front wheel, vibration of a portion of a vehicle body that corresponds to the position of the rear wheel cannot be reduced. Further, the vibration of the portion of the vehicle body may increase. In view of this, the related-art device estimates a degree of overlap between the road surface where the front wheel passes and the road surface where the rear wheel passes when the vehicle makes a turn. When the degree of overlap is small, the related-art device reduces a gain of the preview damping control for the rear wheel (or does not execute the preview damping control for the rear wheel).

### SUMMARY

When the vehicle makes a turn, the related-art device reduces the gain of the preview damping control for the rear wheel (or does not execute the preview damping control for the rear wheel). Therefore, there is a possibility that the vibration of the portion of the vehicle body that corresponds to the position of the rear wheel is not reduced when the vehicle makes a turn.

The present disclosure provides a technology in which the vibration of the portion of the vehicle body that corresponds to the position of the rear wheel can be reduced even when the vehicle makes a turn.

A first aspect of the present disclosure relates to a damping control device for a vehicle including front wheels and rear wheels. The damping control device includes:
a control force generating device configured to generate a vertical damping control force for damping a sprung portion of the vehicle between at least one of the rear wheels and a portion of a vehicle body that corresponds to a position of the at least one of the rear wheels;
a first information acquirer configured to acquire first information related to a vertical displacement of a road surface at a predicted passing position where the one of the rear wheels is predicted to pass at a timing when a predetermined period has elapsed from a current time, the first information including at least one of a road surface displacement that is the vertical displacement of the road surface at the predicted passing position, a road surface displacement speed that is a time derivative of the road surface displacement at the predicted passing position, an unsprung displacement that is a vertical displacement of an unsprung portion of the vehicle at the predicted passing position, and an unsprung speed that is a time derivative of the unsprung displacement at the predicted passing position;
a second information acquirer configured to acquire second information related to a vertical displacement of the vehicle body of the vehicle, the second information including at least one of a sprung displacement that is a vertical displacement of the sprung portion, a sprung speed that is a time derivative of the sprung displacement, a sprung acceleration that is a second-order time derivative of the sprung displacement, the unsprung displacement, and the unsprung speed; and
a control unit configured to control the control force generating device to change the damping control force.
The control unit is configured to:
   calculate, based on the first information, a first control force of feedforward control for damping the sprung portion when the one of the rear wheels passes through the predicted passing position;
   calculate, based on the second information, a second control force of feedback control for damping the sprung portion; and
   calculate a weighted sum of the first control force and the second control force as a target value of the damping control force.
The control unit is further configured to:
   calculate a degree of a deviation of a path of the one of the rear wheels from a path of one of the front wheels; and
   set, when determining that the degree of the deviation is larger than a predetermined first degree, a second weight for the second control force to be larger than a first weight for the first control force in the weighted sum.

As described above, the damping control device calculates the damping control force containing a feedforward control component (first control force) and a feedback control component (second control force). When the degree of the deviation is larger than the first degree (for example, the vehicle is making a turn), the damping control device sets the second weight for the second control force to be larger than the first weight for the first control force. Thus, when the vehicle makes a turn, the damping control device can gradually reduce the vibration of the sprung portion by the feedback control component while reducing a possibility that the feedforward control component adversely affects the vibration of the sprung portion.

The control unit may be configured to change the first weight for the first control force and the second weight for the second control force by using a relationship between a contact width of a tire of the vehicle and a magnitude of a difference between a turning radius of the one of the front wheels and a turning radius of the one of the rear wheels.

According to the configuration described above, the control unit can change, based on the relationship described above, the first weight for the first control force and the second weight for the second control force depending on the degree of overlap between a road surface where the one of the front wheels passes and a road surface where the one of the rear wheels passes.

The control unit may be configured to change the first weight for the first control force and the second weight for the second control force to reduce the first weight for the first control force and increase the second weight for the second control force as the degree of the deviation increases.

According to the configuration described above, the control unit calculates the damping control force to reduce the feedforward control component and increase the feedback control component as the degree of the deviation increases. Thus, depending on the degree of the deviation, the damping control device can further reduce the adverse effect of the feedforward control component, and can further increase the effect of reducing the vibration by the feedback control component.

The control unit may be configured to set the first weight for the first control force to zero when determining that the degree of the deviation is larger than a second degree that is larger than the first degree.

According to the configuration described above, when the degree of the deviation is larger than the second degree, the feedforward control component of the damping control force is zero. Thus, the damping control device can gradually reduce the vibration of the sprung portion by the feedback control component while avoiding (eliminating) the adverse effect of the feedforward control component.

A second aspect of the present disclosure relates to a damping control method for a vehicle including front wheels, rear wheels, and a control force generating device configured to generate a vertical damping control force for damping a sprung portion between at least one of the rear wheels and a portion of a vehicle body that corresponds to a position of the at least one of the rear wheels. The damping control method includes:
acquiring first information related to a vertical displacement of a road surface at a predicted passing position where the one of the rear wheels is predicted to pass at a timing when a predetermined period has elapsed from a current time, the first information including at least one of a road surface displacement that is the vertical displacement of the road surface at the predicted passing position, a road surface displacement speed that is a time derivative of the road surface displacement at the predicted passing position, an unsprung displacement that is a vertical displacement of an unsprung portion of the vehicle at the predicted passing position, and an unsprung speed that is a time derivative of the unsprung displacement at the predicted passing position;
acquiring second information related to a vertical displacement of the vehicle body of the vehicle, the second information including at least one of a sprung displacement that is a vertical displacement of the sprung portion, a sprung speed that is a time derivative of the sprung displacement, a sprung acceleration that is a second-order time derivative of the sprung displacement, the unsprung displacement, and the unsprung speed; and controlling the control force generating device to change the damping control force.
The controlling includes:
   calculating, based on the first information, a first control force of feedforward control for damping the sprung portion when the one of the rear wheels passes through the predicted passing position;
   calculating, based on the second information, a second control force of feedback control for damping the sprung portion; and
   calculating a weighted sum of the first control force and the second control force as a target value of the damping control force.
The calculating the weighted sum includes:
   calculating a degree of a deviation of a path of the one of the rear wheels from a path of one of the front wheels; and
   setting, when determining that the degree of the deviation is larger than a predetermined first degree, a second weight for the second control force to be larger than a first weight for the first control force in the weighted sum.

The control unit may be implemented by a microprocessor programmed to perform one or more functions described herein. The control unit may entirely or partially be implemented by hardware including one or more application-specific integrated circuits, that is, ASICs.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic structural diagram of a vehicle to which a damping control device according to one or more embodiments is applied;

FIG. 2 is a schematic structural diagram of the damping control device according to the one or more embodiments;

FIG. 3 is a diagram illustrating a single-wheel model of a vehicle;

FIG. 4 is a diagram for describing preview damping control;

FIG. 5 is a diagram for describing the preview damping control;

FIG. 6 is a diagram for describing the preview damping control;

FIG. 7 is a diagram for describing an inner wheel turning radius difference and an outer wheel turning radius difference when the vehicle makes a turn;

FIG. 8 is a diagram of an example of a map MP1 showing a relationship between a deviation-related value ΔRd and a weight “a” for a first target control force Fff_r;

FIG. 9 is a flowchart illustrating a routine to be executed by a central processing unit (CPU) of an electronic control unit according to the one or more embodiments;

FIG. 10 is a flowchart illustrating a routine to be executed by the CPU of the electronic control unit in Step 905 of the routine of FIG. 9; and

FIG. 11 is a diagram of an example of a map MP2 showing a relationship between the deviation-related value ΔRd and a weight “b” for a second target control force Ffb_r.

### DETAILED DESCRIPTION OF EMBODIMENTS

### Structure

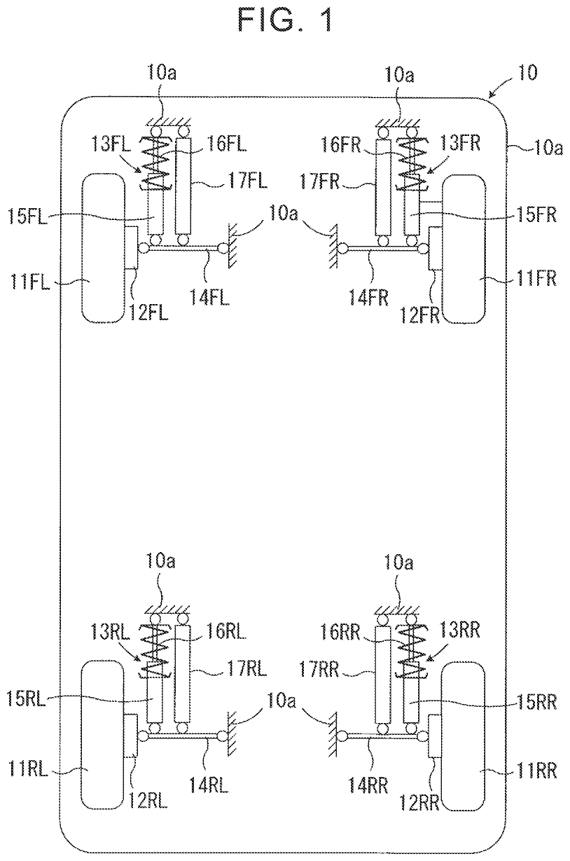

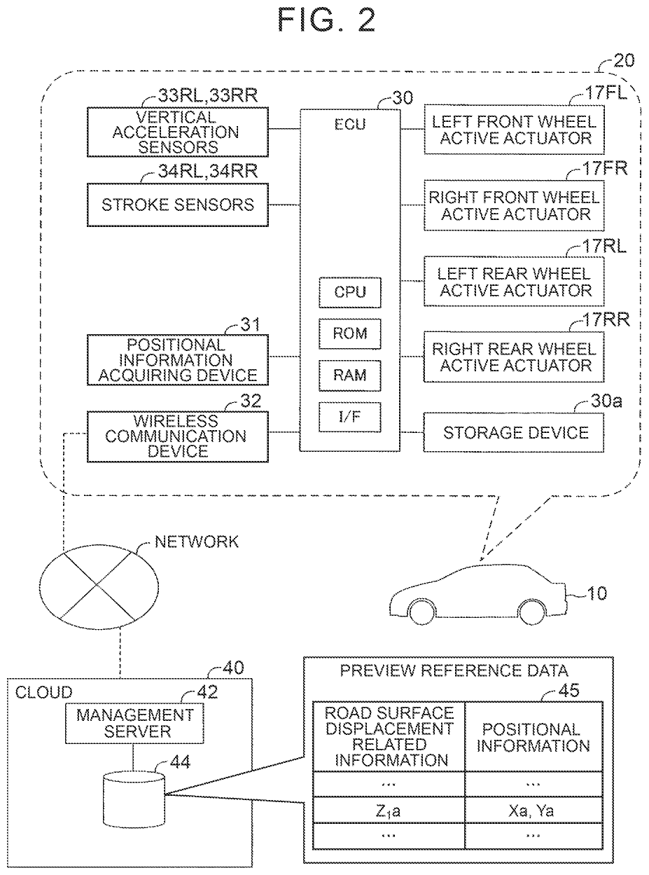

A damping control device according to one or more embodiments is applied to a vehicle 10 illustrated in FIG. 1. As illustrated in FIG. 2, the damping control device is hereinafter referred to also as “damping control device 20”.

As illustrated in FIG. 1, the vehicle 10 includes a right front wheel 11FR, a left front wheel 11FL, a right rear wheel 11RR, and a left rear wheel 11RL. The right front wheel 11FR is rotatably supported on a vehicle body 10a by a wheel support member 12FR. The left front wheel 11FL is rotatably supported on the vehicle body 10a by a wheel support member 12FL. The right rear wheel 11RR is rotatably supported on the vehicle body 10a by a wheel support member 12RR. The left rear wheel 11RL is rotatably supported on the vehicle body 10a by a wheel support member 12RL.

The right front wheel 11FR, the left front wheel 11FL, the right rear wheel 11RR, and the left rear wheel 11RL are referred to as “wheels 11” unless otherwise distinguished. Similarly, the right front wheel 11FR and the left front wheel 11FL are referred to as “front wheels 11F”. Similarly, the right rear wheel 11RR and the left rear wheel 11RL are referred to as “rear wheels 11R”. The wheel support members 12FR to 12RL are referred to as “wheel support members 12”.

The vehicle 10 further includes a right front wheel suspension 13FR, a left front wheel suspension 13FL, a right rear wheel suspension 13RR, and a left rear wheel suspension 13RL. Details of the suspensions 13FR to 13RL are described below. The suspensions 13FR to 13RL are independent suspensions, but other types of suspension may be employed.

The right front wheel suspension 13FR suspends the right front wheel 11FR from the vehicle body 10a, and includes a suspension arm 14FR, a shock absorber 15FR, and a suspension spring 16FR. The left front wheel suspension 13FL suspends the left front wheel 11FL from the vehicle body 10a, and includes a suspension arm 14FL, a shock absorber 15FL, and a suspension spring 16FL.

The right rear wheel suspension 13RR suspends the right rear wheel 11RR from the vehicle body 10a, and includes a suspension arm 14RR, a shock absorber 15RR, and a suspension spring 16RR. The left rear wheel suspension 13RL suspends the left rear wheel 11RL from the vehicle body 10a, and includes a suspension arm 14RL, a shock absorber 15RL, and a suspension spring 16RL.

The right front wheel suspension 13FR, the left front wheel suspension 13FL, the right rear wheel suspension 13RR, and the left rear wheel suspension 13RL are referred to as “suspensions 13” unless otherwise distinguished. Similarly, the suspension arms 14FR to 14RL are referred to as “suspension arms 14”. Similarly, the shock absorbers 15FR to 15RL are referred to as “shock absorbers 15”. Similarly, the suspension springs 16FR to 16RL are referred to as “suspension springs 16”.

The suspension arm 14 couples the wheel support member 12 to the vehicle body 10a. In FIG. 1, one suspension arm 14 is provided for one suspension 13. In another example, a plurality of suspension arms 14 may be provided for one suspension 13.

The shock absorber 15 is provided between the vehicle body 10a and the suspension arm 14. The upper end of the shock absorber 15 is coupled to the vehicle body 10a. The lower end of the shock absorber 15 is coupled to the suspension arm 14. The suspension spring 16 is provided between the vehicle body 10a and the suspension arm 14 via the shock absorber 15. That is, the upper end of the suspension spring 16 is coupled to the vehicle body 10a, and the lower end of the suspension spring 16 is coupled to a cylinder of the shock absorber 15. In this structure of the suspension spring 16, the shock absorber 15 may be provided between the vehicle body 10a and the wheel support member 12.

In this example, the shock absorber 15 is a non-adjustable shock absorber. In another example, the shock absorber 15 may be an adjustable shock absorber. The suspension spring 16 may be provided between the vehicle body 10a and the suspension arm 14 without intervention of the shock absorber 15. That is, the upper end of the suspension spring 16 may be coupled to the vehicle body 10a, and the lower end of the suspension spring 16 may be coupled to the suspension arm 14. In this structure of the suspension spring 16, the shock absorber 15 and the suspension spring 16 may be provided between the vehicle body 10a and the wheel support member 12.

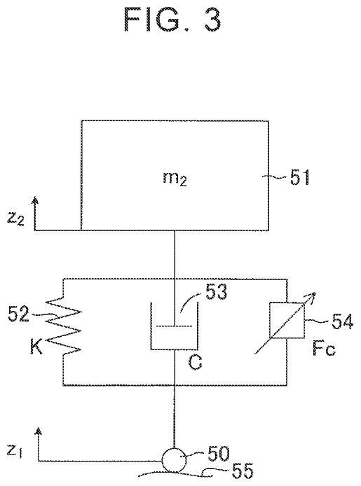

Regarding the members such as the wheel 11 and the shock absorber 15 of the vehicle 10, a portion close to the wheel 11 with respect to the suspension spring 16 is referred to as “unsprung portion 50 or unsprung member 50 (see FIG. 3)”. Regarding the members such as the vehicle body 10a and the shock absorber 15 of the vehicle 10, a portion close to the vehicle body 10a with respect to the suspension spring 16 is referred to as “sprung portion 51 or sprung member 51 (see FIG. 3)”.

A right front wheel active actuator 17FR, a left front wheel active actuator 17FL, a right rear wheel active actuator 17RR, and a left rear wheel active actuator 17RL are provided between the vehicle body 10a and the suspension arms 14FR to 14RL, respectively. The active actuators 17FR to 17RL are provided in parallel to the shock absorbers 15FR to 15RL and the suspension springs 16FR to 16RL, respectively.

The right front wheel active actuator 17FR, the left front wheel active actuator 17FL, the right rear wheel active actuator 17RR, and the left rear wheel active actuator 17RL are referred to as “active actuators 17” unless otherwise distinguished. Similarly, the right front wheel active actuator 17FR and the left front wheel active actuator 17FL are referred to as “front wheel active actuators 17F”. Similarly, the right rear wheel active actuator 17RR and the left rear wheel active actuator 17RL are referred to as “rear wheel active actuators 17R”.

The active actuator 17 generates a control force Fc based on a control command from an electronic control unit 30 illustrated in FIG. 2. The control force Fc is a vertical force acting between the vehicle body 10a and the wheel 11 (that is, between the sprung portion 51 and the unsprung portion 50) to damp the sprung portion 51. Thus, the control force Fc may be referred to also as “damping control force”. The electronic control unit 30 is referred to as “ECU 30”, and may be referred to as “control unit or controller”. The active actuator 17 may be referred to as “control force generating device”. The active actuator 17 is an electromagnetic active suspension. The active actuator 17 serves as the active suspension in cooperation with, for example, the shock absorber 15 and the suspension spring 16.

As illustrated in FIG. 2, the damping control device 20 includes the ECU 30, a storage device 30a, a positional information acquiring device 31, a wireless communication device 32, vertical acceleration sensors 33RR and 33RL, and stroke sensors 34RR and 34RL. The damping control device 20 further includes the active actuators 17FR to 17RL.

The ECU 30 includes a microcomputer. The microcomputer includes a CPU, a read-only memory (ROM), a random-access memory (RAM), and an interface (I/F). The CPU executes instructions (programs or routines) stored in the ROM to implement various functions.

The ECU 30 is connected to the non-volatile storage device 30a in which information is readable and writable. In this example, the storage device 30a is a hard disk drive. The ECU 30 can store information in the storage device 30a, and can read information stored in the storage device 30a. The storage device 30a is not limited to the hard disk drive, and may be a known storage device or storage medium in which information is readable and writable.

The ECU 30 is connected to the positional information acquiring device 31 and the wireless communication device 32.

The positional information acquiring device 31 includes a global navigation satellite system (GNSS) receiver and a map database. The GNSS receiver receives “signal from artificial satellite (for example, GNSS signal)” for detecting a position of the vehicle 10 at a current time (current position). The map database stores road map information and the like. The positional information acquiring device 31 acquires the current position (for example, latitude and longitude) of the vehicle 10 based on the GNSS signal. Examples of the positional information acquiring device 31 include a navigation device.

The ECU 30 acquires “vehicle speed V1 of vehicle 10 and traveling direction Td of vehicle 10” at a current time from the positional information acquiring device 31.

The wireless communication device 32 is a wireless communication terminal for communicating information with a cloud 40 via a network. The cloud 40 includes “management server 42 and at least one storage device 44” connected to the network.

The management server 42 includes a CPU, a ROM, a RAM, and an interface (I/F). The management server 42 retrieves and reads data stored in the storage device 44, and writes data into the storage device 44.

The storage device 44 stores preview reference data 45. “Road surface displacement related information and positional information” are registered in the preview reference data 45 while being linked to (associated with) each other.

The road surface displacement related information is related to a vertical displacement of a road surface of a road, which indicates undulations of the road surface, and may be referred to also as “first information”. Specifically, the road surface displacement related information includes at least one of a road surface displacement z₀ that is the vertical displacement of the road surface, a road surface displacement speed dz₀ that is a time derivative of the road surface displacement z₀, an unsprung displacement z₁ that is a vertical displacement of the unsprung portion 50, and an unsprung speed dz₁ that is a time derivative of the unsprung displacement z₁. In this example, the road surface displacement related information is the unsprung displacement z₁. When the vehicle 10 travels along the road surface, the unsprung portion 50 is displaced in the vertical direction in response to the displacement of the road surface. The unsprung displacement z₁ is a vertical displacement of the unsprung portion 50 associated with a position of each wheel 11 of the vehicle 10.

The positional information indicates a position (for example, latitude and longitude) of the road surface associated with the road surface displacement related information. FIG. 2 illustrates an unsprung displacement “Z₁a” and positional information “Xa, Ya” as examples of “unsprung displacement z₁ and positional information” registered as the preview reference data 45.

The ECU 30 is connected to the vertical acceleration sensors 33RR and 33RL and the stroke sensors 34RR and 34RL, and receives signals output from those sensors.

The vertical acceleration sensors 33RR and 33RL are provided on the vehicle body 10a (sprung portion 51) at positions corresponding to the positions of the right rear wheel 11RR and the left rear wheel 11RL, respectively. The acceleration sensors 33RR and 33RL are referred to as “vertical acceleration sensors 33” unless otherwise distinguished. The vertical acceleration sensors 33RR and 33RL detect vertical accelerations (ddz₂RR and ddz₂RL) of the sprung portion 51 at positions corresponding to the positions of the right rear wheel 11RR and the left rear wheel 11RL, and output signals indicating the vertical accelerations, respectively. The accelerations ddz₂RR and ddz₂RL are referred to as “sprung accelerations ddz₂” unless otherwise distinguished. The sprung acceleration ddz₂ is information related to a vertical displacement of the vehicle body 10a, and may be referred to also as “vehicle body displacement related information” or “second information”.

The stroke sensors 34RR and 34RL are provided on the right rear wheel suspension 13RR and the left rear wheel suspension 13RL, respectively. The stroke sensors 34RR and 34RL detect vertical strokes (Hrr and Hrl) of the suspensions 13RR and 13RL, and output signals indicating the vertical strokes, respectively. The strokes Hrr and Hrl are vertical strokes between the wheel support members 12RR and 12RL and portions of the vehicle body 10a (sprung portion 51) that correspond to the positions of the rear wheels 11R illustrated in FIG. 1, respectively. The stroke sensors 34RR and 34RL are referred to as “stroke sensors 34” unless otherwise distinguished. Similarly, the strokes Hrr and Hrl are referred to as “strokes H”.

The ECU 30 is connected to the right front wheel active actuator 17FR, the left front wheel active actuator 17FL, the right rear wheel active actuator 17RR, and the left rear wheel active actuator 17RL via drive circuits (not illustrated).

The ECU 30 calculates a target control force Fct for damping the sprung portion 51 of each wheel 11, and controls the active actuator 17 such that the active actuator 17 generates a control force that corresponds to (agrees with) the target control force Fct when each wheel 11 passes through a predicted passing position.

### Overview of Basic Preview Damping Control

An overview of basic preview damping control to be executed by the damping control device 20 is described below. FIG. 3 illustrates a single-wheel model of the vehicle 10 on a road surface 55.

A spring 52 corresponds to the suspension spring 16. A damper 53 corresponds to the shock absorber 15. An actuator 54 corresponds to the active actuator 17.

In FIG. 3, a mass of the sprung portion 51 is referred to as “sprung mass m₂”. A vertical displacement of the sprung portion 51 is referred to as “sprung displacement z₂”. The sprung displacement z₂ is a vertical displacement of the sprung portion 51 associated with a position of each wheel 11. A spring rate (equivalent spring rate) of the spring 52 is referred to as “spring rate K”. A damping coefficient (equivalent damping coefficient) of the damper 53 is referred to as “damping coefficient C”. A force generated by the actuator 54 is referred to as “control force Fc”. Similarly to the above, a symbol “z₁” represents a vertical displacement of the unsprung portion 50 (unsprung displacement).

Time derivatives of z₁ and z₂ are represented by “dz₁” and “dz₂”, respectively. Second-order time derivatives of z₁ and z₂ are represented by “ddz₁” and “ddz₂”, respectively. In the following description, an upward displacement of each of z₁ and z₂ is defined to be positive, and an upward force generated by each of the spring 52, the damper 53, and the actuator 54 is defined to be positive.

In the single-wheel model of the vehicle 10 illustrated in FIG. 3, an equation of motion regarding a vertical motion of the sprung portion 51 can be represented by Expression (1).

m₂ddz₂=C(dz₁−dz₂)+K(z₁−z₂)−Fc (1)

In Expression (1), the damping coefficient C is assumed to be constant. However, an actual damping coefficient changes depending on a stroke speed of the suspension 13. Therefore, the damping coefficient C may be set to, for example, a value that changes depending on a time derivative of the stroke H.

When vibration of the sprung portion 51 is completely canceled out by the control force Fc (that is, when the sprung acceleration ddz₂, the sprung speed dz₂, and the sprung displacement z₂ are “0”), the control force Fc is represented by Expression (2).

Fc=Cdz₁+Kz₁ (2)

Vibration of the sprung displacement z₂ when the control force Fc is represented by Expression (3) is discussed. In Expression (3), a is an arbitrary constant larger than 0 and equal to or smaller than 1.

Fc=α(Cdz₁+Kz₁) (3)

When Expression (3) is applied to Expression (1), Expression (1) can be represented by Expression (4).

m₂ddz₂=C(dz₁−dz₂)+K(z₁−z₂)−α(Cdz₁+Kz₁) (4)

Expression (5) is obtained when Expression (4) is subjected to Laplace transform and the resultant expression is rearranged. That is, a transfer function from the unsprung displacement z₁ to the sprung displacement z₂ is represented by Expression (5). In Expression (5), “s” represents a Laplace operator.

$$\frac{{z}_{2}}{{z}_{1}} = \frac{( 1 - α ) ( C s + K )}{{m}_{2} {s}^{2} + C s + K} \qquad ( 5 )$$

According to Expression (5), the transfer function changes depending on α. When α is an arbitrary value larger than 0 and equal to or smaller than 1, it is observed that the magnitude of the transfer function is securely smaller than “1” (that is, the vibration of the sprung portion 51 can be reduced). When α is 1, the magnitude of the transfer function is “0”. Therefore, it is observed that the vibration of the sprung portion 51 is completely canceled out. A target control force Fff can be represented by Expression (6) based on Expression (3). In Expression (6), a gain β₁ corresponds to αC, and a gain β₂ corresponds to αK.

Fff=β₁×dz₁+β₂×z₁ (6)

Thus, the ECU 30 calculates the target control force Fff by acquiring in advance (previewing) an unsprung displacement z₁ at a position where the wheel 11 passes in the future (predicted passing position), and applying the acquired unsprung displacement z₁ to Expression (6). The target control force Fff may be referred to also as “feedforward target control force” because the target control force Fff is a target control force for reducing vibration when the wheel 11 passes through the predicted passing position.

The ECU 30 causes the actuator 54 to generate a control force Fc corresponding to the target control force Fff at a timing when the wheel 11 passes through the predicted passing position (that is, at a timing when the unsprung displacement z₁ applied to Expression (6) occurs). With this configuration, the vibration of the sprung portion 51 can be reduced when the wheel 11 passes through the predicted passing position (that is, when the unsprung displacement z₁ applied to Expression (6) occurs).

The ECU 30 may calculate the target control force Fff based on Expression (7) obtained by omitting the derivative term (β₁×dz₁) from Expression (6). Also in this case, the ECU 30 can cause the actuator 54 to generate the control force Fc (=β₂×z₁) for reducing the vibration of the sprung portion 51. Thus, the vibration of the sprung portion 51 can be reduced as compared to a case where the control force Fc is not generated.

Fff=β₂×z₁ (7)

The control described above is damping control for the sprung portion 51, which is referred to as “preview damping control”.

In the single-wheel model, the mass of the unsprung portion 50 and elastic deformation of tires are ignored, and the road surface displacement z₀ that is the vertical displacement of the road surface 55 is assumed to be identical to the unsprung displacement z₁. In another example, similar preview damping control may be executed by using the road surface displacement z₀ and/or the road surface displacement speed dz₀ in place of or in addition to the unsprung displacement z₁.

### Damping Control for Front Wheel and Rear Wheel

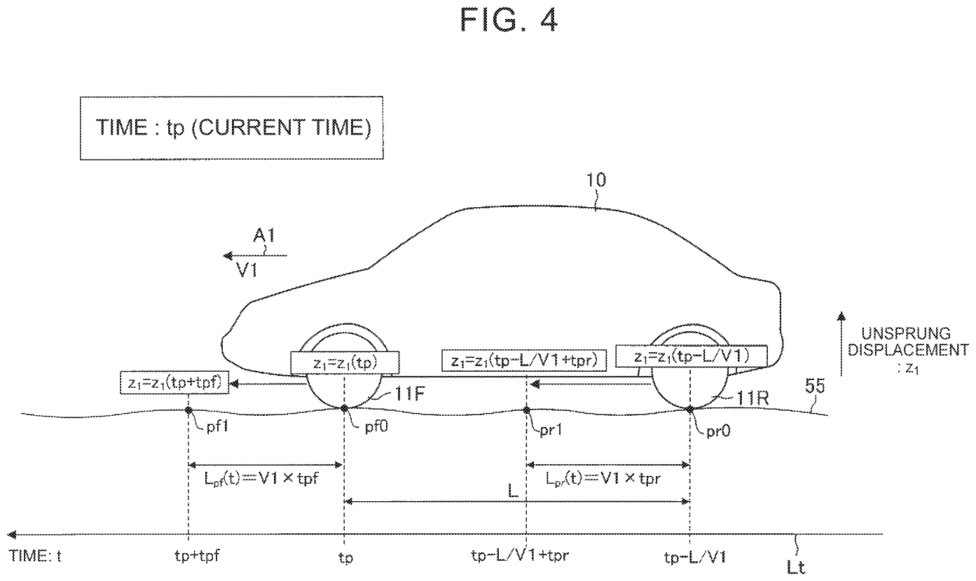

Next, damping control for the front wheel and the rear wheel is described with reference to FIG. 4 to FIG. 6. In the following description, a suffix “_f” assigned to “target control force Fct” and “control force Fc” represents a control force for the front wheel 11F, and a suffix “_r” assigned to “target control force Fct” and “control force Fc” represents a control force for the rear wheel 11R.

FIG. 4 illustrates the vehicle 10 traveling at a vehicle speed V1 in a direction indicated by an arrow A1 at a current time tp. In the following description, the front wheel 11F and the rear wheel 11R are right or left wheels, and the moving speeds of the front wheel 11F and the rear wheel 11R are equal to the vehicle speed V1.

In FIG. 4, a line Lt is a virtual time axis t. Unsprung displacements z₁ of the front wheel 11F on a movement path at current, past, and future times t are represented by a function z₁(t) of the times t. Thus, an unsprung displacement z₁ of the front wheel 11F at a position (contact point) pf0 at the current time tp is represented by z₁(tp). An unsprung displacement z₁ of the rear wheel 11R at a position pr0 at the current time tp corresponds to an unsprung displacement z₁ of the front wheel 11F at a time “tp−L/V1” earlier than the current time tp by “period (L/V1) required for front wheel 11F to move by wheelbase L”. Thus, the unsprung displacement z₁ of the rear wheel 11R at the current time tp is represented by z₁(tp−L/V1).

### Damping Control for Front Wheel 11F

The ECU 30 determines a predicted passing position pf1 of the front wheel 11F at a time later (in the future) than the current time tp by a front wheel preview period tpf. The front wheel preview period tpf is preset to a period required from the timing when the ECU 30 determines the predicted passing position pf1 to the timing when the front wheel active actuator 17F outputs a control force Fc_f corresponding to a target control force Fct_f.

The predicted passing position pf1 of the front wheel 11F is a position spaced away from the position pf0 at the current time tp by a front wheel preview distance L_{pf}(=V1×tpf) along a predicted path of the front wheel 11F. The predicted path of the front wheel 11F means a path where the front wheel 11F is predicted to move. As described later in detail, the position pf0 is calculated based on a current position of the vehicle 10 that is acquired by the positional information acquiring device 31.

The ECU 30 acquires in advance a part of the preview reference data 45 in an area near the current position of the vehicle 10 (preparatory zone described later) from the cloud 40. The ECU 30 acquires an unsprung displacement z₁(tp+tpf) based on the determined predicted passing position pf1 and the part of the preview reference data 45 acquired in advance.

The ECU 30 calculates a feedforward target control force Fff f of the front wheel 11F (=β_{f}×z₁(tp+tpf)) by applying the unsprung displacement z₁(tp+tpf) to the unsprung displacement z₁ in Expression (8). As in Expression (9), the ECU 30 determines the target control force Fff f as a final target control force Fct_f of the front wheel 11F.

Fff_f=β_{f}×z₁ (8)

Fct_f=Fff_f (9)

The ECU 30 transmits a control command containing the target control force Fct_f to the front wheel active actuator 17F to cause the front wheel active actuator 17F to generate a control force Fc_f that corresponds to (agrees with) the target control force Fct_f.

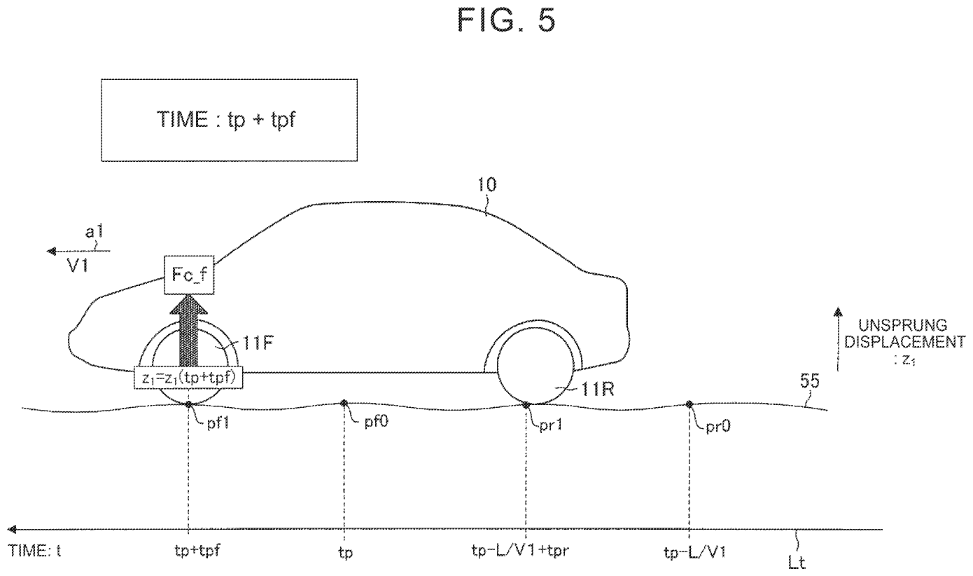

As illustrated in FIG. 5, the front wheel active actuator 17F generates the control force Fc_f corresponding to the target control force Fct_f at “time tp+tpf” (that is, at a timing when the front wheel 11F actually passes through the predicted passing position pf1) later than the current time tp by the front wheel preview period tpf. Thus, the front wheel active actuator 17F can generate, at an appropriate timing, the control force Fc_f for reducing the vibration of the sprung portion 51 that occurs due to the unsprung displacement z₁ of the front wheel 11F at the predicted passing position pf1. In this manner, the ECU 30 executes feedforward control (preview damping control) for the front wheel 11F.

### Damping Control for Rear Wheel 11R

As illustrated in FIG. 4, the ECU 30 determines a predicted passing position pr1 of the rear wheel 11R at a time later (in the future) than the current time tp by a rear wheel preview period tpr. The rear wheel preview period tpr is preset to a period required from the timing when the ECU 30 determines the predicted passing position pr1 to the timing when the rear wheel active actuator 17R outputs a control force Fc_r corresponding to a target control force Fct_r. If the front wheel active actuator 17F and the rear wheel active actuator 17R have different responses, the front wheel preview period tpf and the rear wheel preview period tpr are preset to different values. If the front wheel active actuator 17F and the rear wheel active actuator 17R have the same response, the front wheel preview period tpf and the rear wheel preview period tpr are preset to the same value.

The ECU 30 determines, as the predicted passing position pr1, a position spaced away from the position pr0 at the current time tp by a rear wheel preview distance Lₚᵣ (=V1×tpr) along a predicted path of the rear wheel 11R under the assumption that the rear wheel 11R moves along the same path as that of the front wheel 11F. The position pr0 is calculated based on the current position of the vehicle 10 that is acquired by the positional information acquiring device 31. An unsprung displacement z₁ at the predicted passing position pr1 can be represented by z₁(tp−L/V1+tpr) because this unsprung displacement z₁ occurs at a time later than “time (tp−L/V1) when front wheel 11F was located at position pr0 of rear wheel 11R at current time” by the rear wheel preview period tpr. The ECU 30 acquires the unsprung displacement z₁(tp−L/V1+tpr) based on the determined predicted passing position pr1 and the part of the preview reference data 45 acquired in advance.

The ECU 30 calculates a feedforward target control force Fff_r of the rear wheel 11R (=βᵣ×z₁(tp−L/V1+tpr)) by applying the unsprung displacement z₁(tp−L/V1+tpr) to the unsprung displacement z₁ in Expression (10). The gain β_{f} in Expression (8) and the gain βr in Expression (10) are set to different values. This is because a spring rate Kf of the right front wheel suspension 13FR and the left front wheel suspension 13FL differs from a spring rate Kr of the right rear wheel suspension 13RR and the left rear wheel suspension 13RL.

Fff_r=βᵣ×z₁ (10)

When the vehicle 10 is making a turn, the rear wheel 11R may move along a path different from that of the front wheel 11F. Considering this case, the ECU 30 of this embodiment calculates a feedback target control force Ffb_r of the rear wheel 11R in addition to the feedforward target control force Fff_r. The feedforward target control force Fff_r of the rear wheel 11R is hereinafter referred to as “first target control force Fff_r”. The feedback target control force Ffb_r of the rear wheel 11R is hereinafter referred to as “second target control force Ffb_r”.

The ECU 30 calculates a weighted sum of the first target control force Fff_r and the second target control force Ffb_r, and determines the weighted sum as the final target control force Fct_r of the rear wheel 11R. The ECU 30 calculates or estimates the degree of a deviation between the path of the front wheel 11F and the path of the rear wheel 11R in a lateral direction of the vehicle 10, and sets a weight “a” for the first target control force Fff_r and a weight “b” for the second target control force Ffb_r based on the degree of the deviation.

Specifically, the ECU 30 acquires a sprung acceleration ddz₂ from the vertical acceleration sensor 33, and determines dz₂ by integrating the sprung acceleration ddz₂. The symbol “dz₂” may hereinafter be referred to as “sprung speed”. The ECU 30 calculates the second target control force Ffb_r based on Expression (11). The second target control force Ffb_r is determined to set dz₂ to 0. In Expression (11), γ₀ represents a gain.

Ffb_r=γ₀×dz₂ (11)

In this example, the ECU 30 calculates a deviation-related value related to the degree of the deviation of the path of the rear wheel 11R from the path of the front wheel 11F. The “deviation of path of rear wheel 11R from path of front wheel 11F” is hereinafter referred to simply as “path deviation”. In this example, the deviation-related value is a magnitude (absolute value) of a difference between a turning radius Rtf of the front wheel 11F and a turning radius Rtr of the rear wheel 11R (ΔRd=|Rtf−Rtr|). The turning radius Rtf and the turning radius Rtr are calculated by a known method (see, for example, Japanese Unexamined Patent Application Publication No. 2008-141875 (JP 2008-141875 A) and International Publication No. 2014/006759 (WO 2014/006759 A)). All the patent documents mentioned herein are incorporated herein by reference in their entirety.

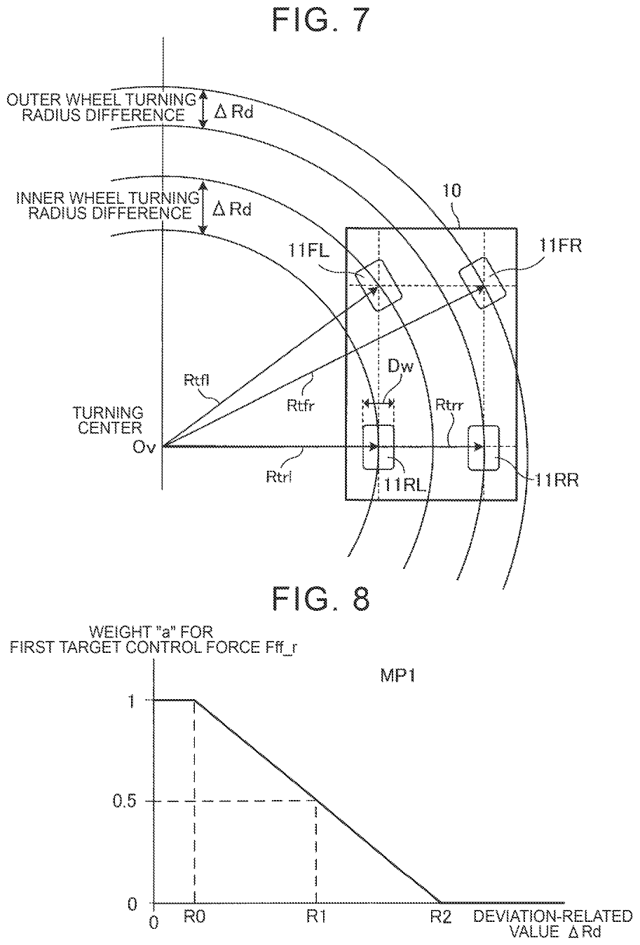

When the vehicle 10 makes a turn to the left as illustrated in FIG. 7, a deviation-related value ΔRd between a turning radius Rtfr of the right front wheel 11FR and a turning radius Rtrr of the right rear wheel 11RR (=|Rtfr−Rtrr|) corresponds to so-called “outer wheel turning radius difference”. A deviation-related value ΔRd between a turning radius Rtfl of the left front wheel 11FL and a turning radius Rtrl of the left rear wheel 11RL (=|Rtfl−Rtrl|) corresponds to so-called “inner wheel turning radius difference”.

When the vehicle 10 makes a turn to the right, the deviation-related value ΔRd between the turning radius Rtfr of the right front wheel 11FR and the turning radius Rtrr of the right rear wheel 11RR corresponds to “inner wheel turning radius difference”. The deviation-related value ΔRd between the turning radius Rtfl of the left front wheel 11FL and the turning radius Rtrl of the left rear wheel 11RL corresponds to “outer wheel turning radius difference”.

In this example, the degree of the path deviation increases as the deviation-related value ΔRd increases. The ECU 30 determines the weight “a” for the first target control force Fff_r by applying the deviation-related value ΔRd to a map MP1(ΔRd) illustrated in FIG. 8. The ECU 30 calculates the weight “b” for the second target control force Ffb_r based on Expression (12).

b=1−a (12)

The ECU 30 calculates the final target control force Fct_r based on Expression (13).

Fct_r=a×Fff_r+b×Ffb_r (13)

The ECU 30 transmits a control command containing the target control force Fct_r to the rear wheel active actuator 17R to cause the rear wheel active actuator 17R to generate a control force Fc_r that corresponds to (agrees with) the target control force Fct_r.

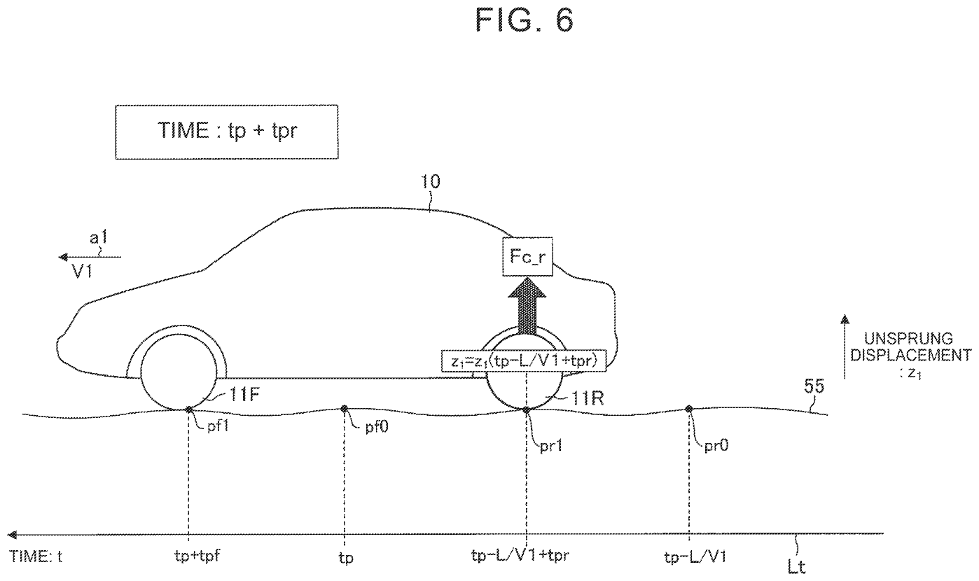

As illustrated in FIG. 6, the rear wheel active actuator 17R generates the control force Fc_r corresponding to the target control force Fct_r at “time tp+tpr” (that is, at a timing when the rear wheel 11R actually passes through the predicted passing position pr1) later than the current time tp by the rear wheel preview period tpr. Thus, the rear wheel active actuator 17R can generate the control force Fc_r for appropriately reducing the vibration of the sprung portion 51 that occurs due to the unsprung displacement z₁ of the rear wheel 11R at the predicted passing position pr1.

According to the map MP1, the weight “a” for the first target control force Fff_r decreases as the deviation-related value ΔRd increases (that is, the degree of the path deviation increases). A contact width of a tire is hereinafter represented by “Dw”. In the map MP1, the weight “a” for the first target control force Fff_r is defined based on a relationship between the deviation-related value (ΔRd) and the contact width Dw of the tire of the vehicle (see FIG. 7).

In the map MP1, for example, R0=Dw/5 holds. When ΔRd is equal to or smaller than R0, the weight “a” is “1” and the weight “b” is “0”. When the deviation-related value ΔRd is small (that is, the degree of the path deviation is small), the final target control force Fct_r contains only the feedforward control component (Fff_r). Since the degree of overlap between the path of the front wheel 11F and the path of the rear wheel 11R is high, the ECU 30 can reduce the vibration of the sprung portion 51 by executing feedforward control (preview damping control) by using the road surface displacement related information (z₁) used for the front wheel 11F.

In the map MP1, for example, R1=Dw/2 holds. When ΔRd is R1, the weight “a” is “0.5” and the weight “b” is “0.5”. In this case, the final target control force Fct_r contains the feedforward control component (Fff_r) and the feedback control component (Ffb_r) at the same weight.

When ΔRd is larger than R1 (the degree of the path deviation is larger than a first degree), the weight “b” for the second target control force Ffb_r is larger than the weight “a” for the first target control force Fff_r. When the degree of overlap between the path of the front wheel 11F and the path of the rear wheel 11R is small, the feedback control component (Ffb_r) may be larger than the feedforward control component (Fff_r) in the target control force Fct_r. Thus, vibration of a portion of the vehicle body near the rear wheel 11R can gradually be reduced by the feedback control component (Ffb_r) while reducing a possibility that the feedforward control component (Fff_r) adversely affects the vibration of the sprung portion 51.

In a range in which ΔRd is larger than R0 and equal to or smaller than R2 (R0<ΔRd R2), the weight “a” for the first target control force Fff_r gradually decreases and the weight “b” for the second target control force Ffb_r gradually increases as ΔRd increases (the degree of the path deviation increases). Depending on the degree of the path deviation, the adverse effect of the feedforward control component (Fff_r) can further be reduced, and the effect of reducing the vibration by the feedback control component (Ffb_r) can further be increased.

In the map MP1, R2=Dw holds. When ΔRd is larger than R2 (the degree of the path deviation is larger than a second degree), the path of the front wheel 11F and the path of the rear wheel 11R do not overlap each other. In this case, the weight “a” is “0” and the weight “b” is “1”. The final target control force Fct_r contains only the feedback control component (Ffb_r). Thus, the vibration of the sprung portion 51 can gradually be reduced by the feedback control component while avoiding (eliminating) the adverse effect of the feedforward control component.

When the degree of overlap between the path of the front wheel 11F and the path of the rear wheel 11R is small, there is a strong possibility that an unsprung displacement z₁ on a road surface where the rear wheel 11R passes differs from an unsprung displacement z₁ on a road surface where the front wheel 11F passes. When the preview damping control is executed for the rear wheel 11R by using only the unsprung displacement z₁ of the front wheel 11F in this situation, the vibration of the portion of the vehicle body that corresponds to the position of the rear wheel 11R may increase.

According to this embodiment, the weight “a” for the first target control force Fff_r decreases and the weight “b” for the second target control force Ffb_r increases in the final target control force Fct_r as the degree of overlap between the path of the front wheel 11F and the path of the rear wheel 11R decreases. When the deviation-related value ΔRd is larger than a certain threshold (R1 in this example), the weight “b” for the second target control force Ffb_r is larger than the weight “a” for the first target control force Fff_r in the weighted sum. Thus, the vibration of the sprung portion 51 near the rear wheel 11R can gradually be reduced by the feedback control component (Ffb_r) while reducing the possibility that the feedforward control component (Fff_r) adversely affects the vibration of the portion of the vehicle body (sprung portion 51) near the rear wheel 11R. Accordingly, the vibration of the sprung portion 51 near the rear wheel 11R can be reduced even if the degree of overlap between the path of the front wheel 11F and the path of the rear wheel 11R decreases when the vehicle 10 makes a turn. The ECU 30 changes the weight “a” for the first target control force Fff_r and the weight “b” for the second target control force Ffb_r by using the relationship between the deviation-related value ΔRd and the contact width Dw of the tire (MP1). According to this configuration, the ECU 30 can change, based on the relationship described above, the weight “a” for the first target control force Fff_r and the weight “b” for the second target control force Ffb_r depending on the degree of overlap between the road surface where the front wheel 11F passes and the road surface where the rear wheel 11R passes.

### Damping Control Routine

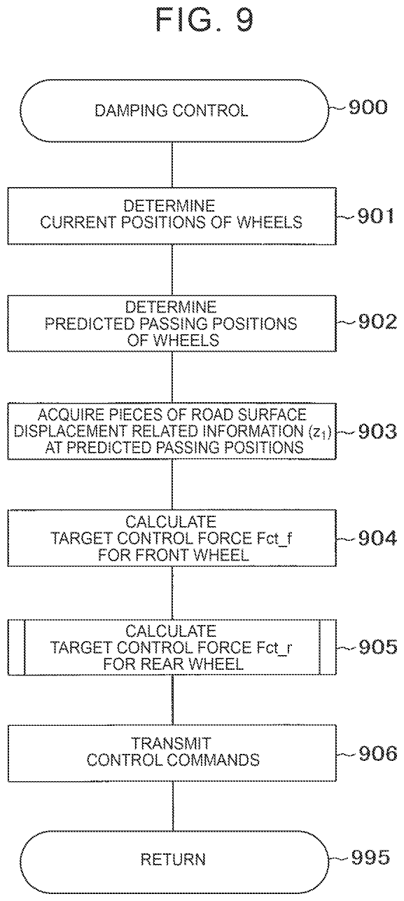

The CPU of the ECU 30 (“CPU” hereinafter refers to the CPU of the ECU 30 unless otherwise noted) executes a damping control routine illustrated in a flowchart of FIG. 9 every time a predetermined period has elapsed. The CPU executes the damping control routine for each of the right wheels (11FR and 11RR) and the left wheels (11FL and 11RL).

The CPU executes a routine (not illustrated) every time a predetermined period has elapsed to acquire in advance preview reference data 45 in a preparatory zone from the cloud 40 and temporarily store the preview reference data 45 in the RAM. The preparatory zone has a start point at a front wheel predicted passing position pf1 when the vehicle 10 reaches the end point of a previous preparatory zone, and has an end point at a position spaced away from the front wheel predicted passing position pf1 by a predetermined preparatory distance along a traveling direction Td of the vehicle 10. The preparatory distance is preset to a value sufficiently larger than the front wheel preview distance L_{pf}.

At a predetermined timing, the CPU starts a process from Step 900 of FIG. 9, and executes Step 901 to Step 906 in this order. Then, the CPU proceeds to Step 995 to temporarily terminate this routine.

Step 901: The CPU determines current positions of the wheels 11.

More specifically, the CPU determines (acquires) a current position of the vehicle 10, a vehicle speed V1, and a traveling direction Td of the vehicle 10 from the positional information acquiring device 31. The ROM of the ECU 30 prestores positional relationship data indicating relationships between a mounting position of the GNSS receiver in the vehicle 10 and the positions of the wheels 11. The current position of the vehicle 10 that is acquired from the positional information acquiring device 31 corresponds to the mounting position of the GNSS receiver. Therefore, the CPU determines the current positions of the wheels 11 by referring to the current position of the vehicle 10, the traveling direction Td of the vehicle 10, and the positional relationship data.

Step 902: The CPU determines predicted passing positions of the wheels 11 as follows.

The CPU determines a predicted path of the front wheel 11F and a predicted path of the rear wheel 11R. As described above, the predicted path of the front wheel 11F is a path where the front wheel 11F is predicted to move in the future, and the predicted path of the rear wheel 11R is a path where the rear wheel 11R is predicted to move in the future. For example, the CPU determines the predicted path of the front wheel 11F based on the current positions of the wheels 11, the traveling direction Td of the vehicle 10, and the positional relationship data. For example, the CPU determines the predicted path of the rear wheel 11R under the assumption that the rear wheel 11R moves along the same path as that of the front wheel 11F.

As described above, the CPU calculates a front wheel preview distance L_{pf} by multiplying the vehicle speed V1 by the front wheel preview period tpf. The CPU determines, as a front wheel predicted passing position pf1, a position of the front wheel 11F that advances from its current position by the front wheel preview distance Lₚf along the predicted path of the front wheel 11F.

The CPU calculates a rear wheel preview distance Lₚᵣ by multiplying the vehicle speed V1 by the rear wheel preview period tpr. The CPU determines, as a rear wheel predicted passing position pr1, a position of the rear wheel 11R that advances from its current position by the rear wheel preview distance Lₚᵣ along the predicted path of the rear wheel 11R.

Step 903: The CPU acquires a road surface displacement related information (z₁) at the front wheel predicted passing position pf1 and a road surface displacement related information (z₁) at the rear wheel predicted passing position pr1 from the RAM.

Step 904: The CPU calculates a target control force Fct_f for the front wheel 11F based on Expression (8) and Expression (9) by using the road surface displacement related information (z₁) at the front wheel predicted passing position pf1.

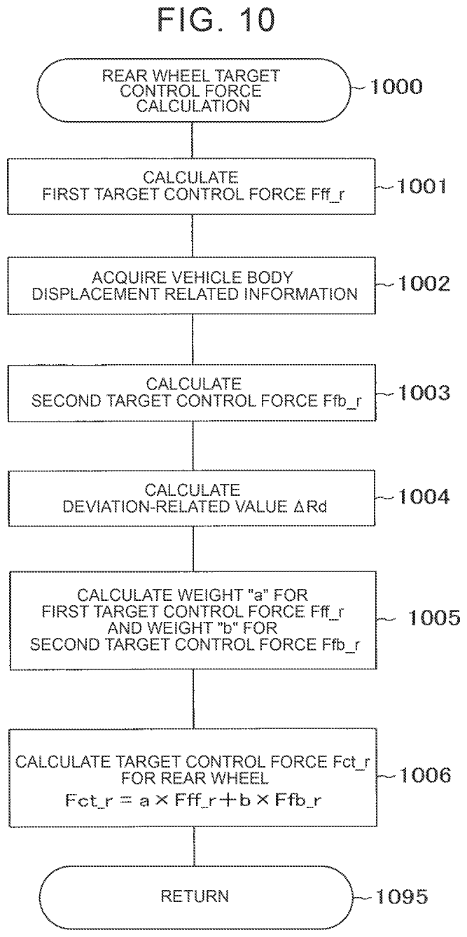

Step 905: The CPU calculates a target control force Fct_r for the rear wheel 11R by executing a routine illustrated in FIG. 10 as described later.

Step 906: The CPU transmits a control command containing the target control force Fct_f to the active actuator 17F. The CPU transmits a control command containing the target control force Fct_r to the active actuator 17R.

When the CPU proceeds to Step 905, the CPU starts a process of the routine illustrated in FIG. 10 from Step 1000, and executes Step 1001 to Step 1006 in this order. Then, the CPU proceeds to Step 1095 to temporarily terminate this routine. Then, the CPU proceeds to Step 906 of the routine of FIG. 9.

Step 1001: The CPU calculates a first target control force Fff_r by applying the road surface displacement related information (z₁) at the rear wheel predicted passing position pr1 to Expression (10).

Step 1002: The CPU acquires a vehicle body displacement related information (sprung acceleration ddz₂) from the vertical acceleration sensor 33. The CPU determines a sprung speed dz₂ by integrating the sprung acceleration ddz₂.

Step 1003: The CPU calculates a second target control force Ffb_r based on Expression (11).

Step 1004: The CPU calculates a deviation-related value ΔRd as described above.

Step 1005: The CPU determines a weight “a” for the first target control force Fff_r by applying the deviation-related value ΔRd to the map MP1(ΔRd). The CPU determines a weight “b” for the second target control force Ffb_r based on Expression (12).

Step 1006: The CPU calculates a target control force Fct_r for the rear wheel 11R based on Expression (13).

As understood from the above, in a situation in which the damping control device 20 estimates that the degree of overlap between the path of the front wheel 11F and the path of the rear wheel 11R decreases when the vehicle 10 makes a turn, the damping control device 20 can gradually reduce the vibration of the sprung portion 51 near the rear wheel 11R by the feedback control component (Ffb_r) while reducing the possibility that the feedforward control component (Fff_r) adversely affects the vibration of the sprung portion 51 near the rear wheel 11R.

The present disclosure is not limited to the embodiment described above, and various modified examples may be adopted within the scope of the present disclosure.

### Modified Example 1

The method for calculating the second target control force Ffb_r is not limited to the method using Expression (11). For example, the expression for calculating the second target control force Ffb_r may include at least one of a term of the sprung displacement z₂, a term of the sprung speed dz₂, a term of the sprung acceleration ddz₂, a term of the unsprung displacement z₁, and a term of the unsprung speed dz₁. For example, the ECU 30 may calculate the second target control force Ffb_r based on Expression (14). Symbols “γ₁”, “γ₂”, “γ₃”, “γ₄”, and “γ₅” represent gains.

Ffb_r=γ₁×ddz₂+γ₂×dz₂+γ₃×z₂+γ₄×dz₁+γ₅×z₁ (14)

In the configuration described above, the ECU 30 can calculate the sprung displacement z₂ through second-order integration of the sprung acceleration ddz₂. The ECU 30 may calculate the unsprung displacement z₁ based on the sprung acceleration ddz₂ and a stroke H. For example, the ECU 30 calculates the sprung displacement z₂ through second-order integration of the sprung acceleration ddz₂. The ECU 30 acquires the stroke H from the stroke sensor 34. The ECU 30 calculates the unsprung displacement z₁ by subtracting the stroke H from the sprung displacement z₂. The ECU 30 may calculate the unsprung speed dz₁ by differentiating the unsprung displacement z₁.

The vehicle 10 may have the vertical acceleration sensors in association with the unsprung portions 50 of the right rear wheel 11RR and the left rear wheel 11RL, respectively. In this case, the ECU 30 may estimate the unsprung displacement z₁ by using an observer (not illustrated) based on one or more parameters out of sprung accelerations ddz₂RR and ddz₂RL, unsprung accelerations ddz₁RR and ddz₁RL, and strokes Hrr and Hrl.

### Modified Example 2

The method for setting the weight “a” for the first target control force Fff_r and the weight “b” for the second target control force Ffb_r is not limited to the method in the example described above. In a first example, the weight “a” for the first target control force Fff_r may decrease nonlinearly and the weight “b” for the second target control force Ffb_r may increase nonlinearly as the deviation-related value ΔRd increases. The ECU 30 sets the weight “a” and the weight “b” so that the weight “b” for the second target control force Ffb_r is larger than the weight “a” for the first target control force Fff_r when the deviation-related value ΔRd is larger than a predetermined threshold Tha1.

In a second example, when the deviation-related value ΔRd is equal to or smaller than a predetermined threshold Thb1, the ECU 30 sets the weight “a” to “1” and the weight “b” to “1”. When the deviation-related value ΔRd is larger than the threshold Thb1, the ECU 30 sets the weight “a” to “0” and the weight “b” to “1”.

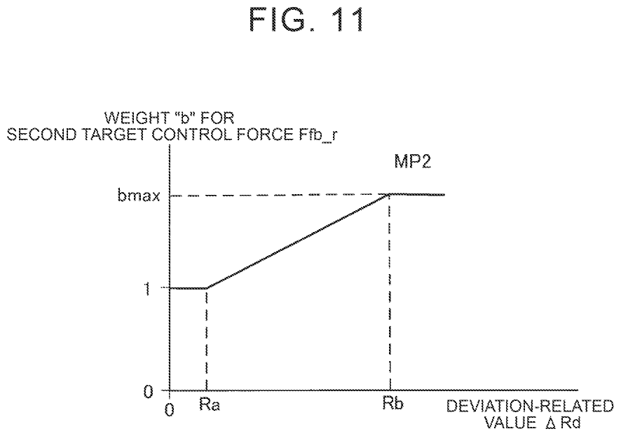

In a third example, the ECU 30 determines the weight “b” for the second target control force Ffb_r by applying the deviation-related value ΔRd to a map MP2(ΔRd) illustrated in FIG. 11. The ECU 30 constantly sets the weight “a” for the first target control force Fff_r to “1”. According to the map MP2, the weight “b” for the second target control force Ffb_r increases as the deviation-related value ΔRd increases (that is, the degree of the path deviation increases). When the deviation-related value ΔRd is larger than a predetermined first threshold Ra, the weight “b” is larger than “1”. For example, the value of Ra is set based on the relationship between the deviation-related value ΔRd and the contact width Dw of the tire similarly to the above. Thus, the weight “b” for the second target control force Ffb_r is larger than the weight “a” for the first target control force Fff_r. When ΔRd is equal to or larger than a predetermined second threshold Rb, the weight “b” is a predetermined maximum value bmax.

### Modified Example 3

The deviation-related value is not limited to the value in the example described above (ΔRd). The deviation-related value may be a value other than ΔRd as long as the value is related to the degree of the deviation of the path of the rear wheel 11R from the path of the front wheel 11F. For example, the deviation-related value may be an overlap ratio Lap obtained by dividing a difference between Dw and ΔRd by Dw as described in JP 2009-119948 A (Lap=(Dw−ΔRd)/Dw). In this configuration, the overlap ratio Lap is “1” when ΔRd is “0”. This means that the path of the front wheel 11F and the path of the rear wheel 11R completely overlap each other. In this case, the ECU 30 may set the weight “a” for the first target control force Fff_r to “1” and the weight “b” for the second target control force Ffb_r to “0”. The overlap ratio Lap decreases as the degree of the path deviation increases. The ECU 30 may set the weight “b” for the second target control force Ffb_r to be larger than the weight “a” for the first target control force Fff_r when the overlap ratio Lap is smaller than a first overlap ratio Lap1 (that is, the degree of the path deviation is larger than the first degree). The ECU 30 may set the weight “a” for the first target control force Fff_r to “0” when the overlap ratio Lap is smaller than a second overlap ratio Lap2 (that is, the degree of the path deviation is larger than the second degree). The second overlap ratio Lap2 is smaller than the first overlap ratio Lap1, and may be, for example, “0”.

In another example, the deviation-related value may be a vehicle condition amount related to a turning condition of the vehicle 10. For example, the deviation-related value may be a combination of one or more vehicle condition amounts such as a speed, a steering angle, a lateral acceleration, and a yaw rate. For example, the ECU 30 may determine the degree of the path deviation by applying the vehicle condition amount to a predetermined map. The ECU 30 may change the weight “a” for the first target control force Fff_r and the weight “b” for the second target control force Ffb_r based on the degree of the deviation.

### Modified Example 4

The ECU 30 may acquire the unsprung displacement z₁(tp+tpf) as follows. First, the ECU 30 transmits the predicted passing position pf1 to the cloud 40. The cloud 40 acquires the unsprung displacement z₁(tp+tpf) linked to positional information indicating the predicted passing position pf1 based on the predicted passing position pf1 and the preview reference data 45. The cloud 40 transmits the unsprung displacement z₁(tp+tpf) to the ECU 30.

### Modified Example 5

The preview reference data 45 need not be stored in the storage device 44 in the cloud 40, but may be stored in the storage device 30a.

### Modified Example 6

The road surface displacement related information may be acquired by a preview sensor provided in the vehicle 10. The ECU 30 is connected to the preview sensor, and acquires the road surface displacement related information from the preview sensor. For example, the preview sensor is attached to an upper-end inner surface of a windshield of the vehicle 10 at the center in a vehicle width direction, and detects a road surface displacement z₀ at a position that is a predetermined preview distance Lₚᵣₑ ahead of the front wheel 11F. The preview sensor may be a publicly known preview sensor in this technical field as long as the road surface displacement z₀ can be acquired like, for example, a camera sensor, a Light Detection and Ranging (LIDAR) sensor, and a radar. The ECU 30 may acquire the road surface displacement z₀ at the predicted passing position based on the road surface displacement z₀ acquired by the preview sensor.

### Modified Example 7

The target control force Fff_r for the feedforward control (preview damping control) on the rear wheels 11R may be calculated by using pieces of road surface displacement related information detected by various sensors provided on the front wheels 11F. For example, the vertical acceleration sensors may be provided on the vehicle body 10a (sprung portion 51) at positions corresponding to the positions of the right front wheel 11FR and the left front wheel 11FL, respectively. The stroke sensors may be provided on the right front wheel suspension 13FR and the left front wheel suspension 13FL, respectively. A sprung acceleration detected by the vertical acceleration sensor provided on the front wheel 11F is hereinafter represented by “ddz₂_f”. A stroke detected by the stroke sensor provided on the front wheel 11F is hereinafter represented by “H_f”.

Similarly to the above, the ECU 30 determines a sprung displacement z₂_f based on the sprung acceleration ddz₂_f, and calculates an unsprung displacement z₁_f by subtracting the stroke H_f from the sprung displacement z₂_f. The ECU 30 saves the unsprung displacement z₁_f in the RAM as an unsprung displacement z₁_f ahead of the rear wheel 11R by linking the unsprung displacement z₁_f to information on a position of the front wheel 11F when the sprung acceleration ddz₂_f is detected. The ECU 30 may calculate a first target control force Fff_r by acquiring an unsprung displacement z₁_f at a rear wheel predicted passing position pr1 from among the unsprung displacements z₁_f ahead of the rear wheel that are saved in the RAM. In this manner, the vertical acceleration sensors and the stroke sensors provided on the front wheels 11F may function as devices configured to acquire pieces of road surface displacement related information ahead of the right and left rear wheels 11RR and 11RL.

### Modified Example 8

The suspensions 13FR to 13RL may be any type of suspension as long as the wheels 11FR to 11RL are allowed to be displaced in the vertical direction relative to the vehicle body 10a. The suspension springs 16FR to 16RL may be arbitrary springs such as compression coil springs or air springs.

### Modified Example 9

In the embodiment described above, the active actuators 17FR to 17RL are provided in correspondence with the respective wheels 11, but the active actuator 17 may be provided to at least one rear wheel 11R. For example, the vehicle 10 may have only the right rear wheel active actuator 17RR and/or the left rear wheel active actuator 17RL.

### Modified Example 10

In the embodiment described above, the active actuator 17 is used as the control force generating device, but the control force generating device is not limited to the active actuator 17. That is, the control force generating device may be an actuator configured to adjustably generate a vertical control force for damping the sprung portion 51 based on a control command containing the target control force.

The control force generating device may be an active stabilizer device (not illustrated). The active stabilizer device includes a front wheel active stabilizer and a rear wheel active stabilizer. When the front wheel active stabilizer generates a vertical control force between the sprung portion 51 and the unsprung portion 50 corresponding to the left front wheel 11FL (left front wheel control force), the front wheel active stabilizer generates a control force in a direction opposite to the direction of the left front wheel control force between the sprung portion 51 and the unsprung portion 50 corresponding to the right front wheel 11FR (right front wheel control force). Similarly, when the rear wheel active stabilizer generates a vertical control force between the sprung portion 51 and the unsprung portion 50 corresponding to the left rear wheel 11RL (left rear wheel control force), the rear wheel active stabilizer generates a control force in a direction opposite to the direction of the left rear wheel control force between the sprung portion 51 and the unsprung portion 50 corresponding to the right rear wheel 11RR (right rear wheel control force). The structure of the active stabilizer device is well known, and is incorporated herein by reference to Japanese Unexamined Patent Application Publication No. 2009-96366 (JP 2009-96366 A). The active stabilizer device may include at least one of the front wheel active stabilizer and the rear wheel active stabilizer.

The control force generating device may be a device configured to generate vertical control forces Fc based on geometry of the suspensions 13FR to 13RL by increasing or reducing braking or driving forces on the wheels 11 of the vehicle 10. The structure of this device is well known, and is incorporated herein by reference to, for example, Japanese Unexamined Patent Application Publication No. 2016-107778 (JP 2016-107778 A). Using a well-known method, the ECU 30 calculates braking or driving forces for generating control forces Fc corresponding to target control forces Fct. The device includes driving devices (for example, in-wheel motors) configured to apply driving forces to the wheels 11, and braking devices (brakes) configured to apply braking forces to the wheels 11. The driving device may be a motor or an engine configured to apply driving forces to the front wheels, the rear wheels, or the four wheels. The control force generating device may include at least one of the driving device and the braking device.

The control force generating device may be each of the adjustable shock absorbers 15FR to 15RL. In this case, the ECU 30 controls the damping coefficients C of the shock absorbers 15FR to 15RL to change damping forces of the shock absorbers 15FR to 15RL by values corresponding to target control forces Fct.

Other objects, other features, and accompanying advantages of the present disclosure will easily be understood from the description of one or more embodiments with reference to the drawings.

What is claimed is:

1. A damping control device for a vehicle including front wheels and rear wheels, the damping control device comprising:
a control force generating device configured to generate a vertical damping control force for damping a sprung portion of the vehicle between at least one of the rear wheels and a portion of a vehicle body that corresponds to a position of the at least one of the rear wheels;
a first information acquirer configured to acquire first information related to a vertical displacement of a road surface at a predicted passing position where the one of the rear wheels is predicted to pass at a timing when a predetermined period has elapsed from a current time, the first information including at least one of a road surface displacement that is the vertical displacement of the road surface at the predicted passing position, a road surface displacement speed that is a time derivative of the road surface displacement at the predicted passing position, an unsprung displacement that is a vertical displacement of an unsprung portion of the vehicle at the predicted passing position, and an unsprung speed that is a time derivative of the unsprung displacement at the predicted passing position;
a second information acquirer configured to acquire second information related to a vertical displacement of the vehicle body of the vehicle, the second information including at least one of a sprung displacement that is a vertical displacement of the sprung portion, a sprung speed that is a time derivative of the sprung displacement, a sprung acceleration that is a second-order time derivative of the sprung displacement, the unsprung displacement, and the unsprung speed; and
a control unit configured to control the control force generating device to change the damping control force, wherein:
the control unit is configured to
calculate, based on the first information, a first control force of feedforward control for damping the sprung portion when the one of the rear wheels passes through the predicted passing position,
calculate, based on the second information, a second control force of feedback control for damping the sprung portion, and
calculate a weighted sum of the first control force and the second control force as a target value of the damping control force; and
the control unit is further configured to
calculate a degree of a deviation of a path of the one of the rear wheels from a path of one of the front wheels, and
set, when determining that the degree of the deviation is larger than a predetermined first degree, a second weight for the second control force to be larger than a first weight for the first control force in the weighted sum.

2. The damping control device according to claim 1, wherein the control unit is configured to change the first weight for the first control force and the second weight for the second control force by using a relationship between a contact width of a tire of the vehicle and a magnitude of a difference between a turning radius of the one of the front wheels and a turning radius of the one of the rear wheels.

3. The damping control device according to claim 1, wherein the control unit is configured to change the first weight for the first control force and the second weight for the second control force to reduce the first weight for the first control force and increase the second weight for the second control force as the degree of the deviation increases.

4. The damping control device according to claim 1, wherein the control unit is configured to set the first weight for the first control force to zero when determining that the degree of the deviation is larger than a second degree that is larger than the first degree.

5. A damping control method for a vehicle including front wheels, rear wheels, and a control force generating device configured to generate a vertical damping control force for damping a sprung portion between at least one of the rear wheels and a portion of a vehicle body that corresponds to a position of the at least one of the rear wheels, the damping control method comprising:
acquiring first information related to a vertical displacement of a road surface at a predicted passing position where the one of the rear wheels is predicted to pass at a timing when a predetermined period has elapsed from a current time, the first information including at least one of a road surface displacement that is the vertical displacement of the road surface at the predicted passing position, a road surface displacement speed that is a time derivative of the road surface displacement at the predicted passing position, an unsprung displacement that is a vertical displacement of an unsprung portion of the vehicle at the predicted passing position, and an unsprung speed that is a time derivative of the unsprung displacement at the predicted passing position;
acquiring second information related to a vertical displacement of the vehicle body of the vehicle, the second information including at least one of a sprung displacement that is a vertical displacement of the sprung portion, a sprung speed that is a time derivative of the sprung displacement, a sprung acceleration that is a second-order time derivative of the sprung displacement, the unsprung displacement, and the unsprung speed; and
controlling the control force generating device to change the damping control force, wherein:
the controlling includes
calculating, based on the first information, a first control force of feedforward control for damping the sprung portion when the one of the rear wheels passes through the predicted passing position,
calculating, based on the second information, a second control force of feedback control for damping the sprung portion, and
calculating a weighted sum of the first control force and the second control force as a target value of the damping control force; and
the calculating the weighted sum includes
calculating a degree of a deviation of a path of the one of the rear wheels from a path of one of the front wheels, and
setting, when determining that the degree of the deviation is larger than a predetermined first degree, a second weight for the second control force to be larger than a first weight for the first control force in the weighted sum.
